(19) United States
(12) Patent Application Publication
(10) Pub. No.: US 2008/0033856 A1
(43) Pub. Date: Feb. 7, 2008

(54) Financial marketplace

(75) Inventors: Assif Stoffman, Kfar Yona (IL); Alon Matas, Givat Shmuel (IL); Guy Hirsch, Tel Aviv (IL)

Correspondence Address: ABELMAN, FRAYNE & SCHWAB, 666 THIRD AVENUE, 10TH FLOOR, NEW YORK, NY, 10017, US

(73) Assignee: Vestopia Inc.

(21) Appl. No.: 11/890,040

(22) Filed: Aug. 2, 2007

Related U.S. Application Data
(60) Provisional application No. 60/835,629, filed on Aug. 3, 2006.

(51) Int. Cl. G06Q 40/00

(52) U.S. Cl. 705/35

(57) ABSTRACT

A method for distributing investment data, includes tracking transactions executed by a plurality of money managers while the transactions are in progress. A selection of at least one money manager from among the plurality is received from a subscriber. Responsively to the selection, information is fed to the subscriber, in exchange for a fee, regarding one or more of the transactions executed subsequent to the selection by the at least one money manager selected by the subscriber.

### CROSS-REFERENCE TO RELATED APPLICATION

This application claims the benefit of U.S. Provisional Patent Application 60/835,629, filed Aug. 3, 2006, which is incorporated herein by reference.

### FIELD OF THE INVENTION

The present invention relates generally to business information systems, and specifically to systems and methods for collecting and supplying information regarding trading in financial instruments.

### BACKGROUND OF THE INVENTION

Many investors place their money in funds that are managed by professional money managers. The money managers generally invest the funds in certain types of financial instruments, such as securities, commodities, and currencies, according to a predefined investment profile. There are tools available to assist investors in comparing different money managers and funds, in order to choose a fund that matches the investor's objectives. For example, Money Manager Review (www.managerreview.com) provides analysis and ranking of the performance of private money managers.

### SUMMARY OF THE INVENTION

The information provided by the types tools that are described above is retrospective, i.e., it relates to the performance of a manager or fund over some period of time in the past. In many cases, investors would like to have information about a money manager's transactions as they are being made. The investors may then be able to benefit from the manager's experience and judgment without necessarily placing their own money under the manager's care. Money managers may be prepared to allow investors to “look over their shoulder” in this manner in exchange for a fee.

Thus, embodiments of the present invention provide an on-line service that gives subscribers an information feed regarding transactions of a selected money manager at the time the transactions are actually made. For this purpose, the service tracks and reports on the transactions of participating money managers in real time. (The tracked transactions may also be used to compile statistics, scores and rankings that subscribers may use in selecting money managers). The service collects fees from subscribers in exchange for provision of the information feed, and shares the collected fees with the money managers according to the information that subscribers receive.

There is therefore provided, in accordance with an embodiment of the present invention, a method for distributing investment data, including:

tracking transactions executed by a plurality of money managers while the transactions are in progress;

receiving from a subscriber a selection of at least one money manager from among the plurality; and

responsively to the selection, feeding information to the subscriber, in exchange for a fee, regarding one or more of the transactions executed subsequent to the selection by the at least one money manager selected by the subscriber.

In one embodiment, the information regarding each transaction is fed to the subscriber within a predetermined time following entry of the transaction by the money manager on a trading workstation. Additionally or alternatively, the information regarding each transaction is fed to the subscriber following entry of the transaction by the money manager on a trading workstation but prior to execution of the transaction.

In a disclosed embodiment, the method includes mimicking, responsively to the information, at least one of the transactions automatically in an account of the subscriber, without waiting to receive instructions from the subscriber regarding the at least one of the transactions.

In some embodiments, receiving the selection includes receiving from the subscriber a choice of a relative delay, from among a plurality of possible relative delays, between entry of the transaction by the money manager on a trading workstation and feeding the information to the subscriber, wherein the fee is dependent upon the choice of the relative delay. Alternatively or additionally, the fee varies depending upon the selection of the at least one money manager. Feeding the information may include charging the subscriber based on a price per transaction reported to the subscriber. Further alternatively or additionally, feeding the information may include charging the subscriber for the information regarding a transaction based on performance of a financial instrument purchased in the transaction.

Typically, tracking the transactions includes providing the subscriber with comparative information regarding investment performance of the managers.

In one embodiment, the at least one money manager includes two or more of the money managers, and feeding the information includes presenting aggregated information regarding the transactions executed by the two or more of the money managers.

In a disclosed embodiment, tracking the transactions includes detecting the transactions executed by the money managers using a client program running on respective workstations used by the money managers to execute the transactions, and reporting the detected transactions from the client program to a service computer, which feeds the information to the subscriber.

In one embodiment, the method includes offering for sale a financial instrument that is indexed according to investment performance of one of the money managers.

There is also provided, in accordance with an embodiment of the present invention, apparatus for distributing investment data, including a service computer, which is coupled to track transactions executed by a plurality of money managers while the transactions are in progress, to receive from a subscriber a selection of at least one money manager from among the plurality, and responsively to the selection, to feed information to the subscriber, in exchange for a fee, regarding one or more of the transactions executed subsequent to the selection by the at least one money manager selected by the subscriber.

There is additionally provided, in accordance with an embodiment of the present invention, a computer software product, including a computer-readable medium in which program instructions are stored, which instructions, when read by a computer, cause the computer to track transactions executed by a plurality of money managers while the transactions are in progress, to receive from a subscriber a selection of at least one money manager from among the plurality, and responsively to the selection, to feed information to the subscriber, in exchange for a fee, regarding one or more of the transactions executed subsequent to the selection by the at least one money manager selected by the subscriber.

The present invention will be more fully understood from the following detailed description of the embodiments thereof, taken together with the drawings in which:

### BRIEF DESCRIPTION OF THE DRAWINGS

FIG. 1 is a block diagram that schematically illustrates a system for collecting and distributing information regarding trading in financial instruments; and

FIG. 2 is a flow chart that schematically illustrates a method for collecting and distributing information regarding trading in financial instruments.

### DETAILED DESCRIPTION OF EMBODIMENTS

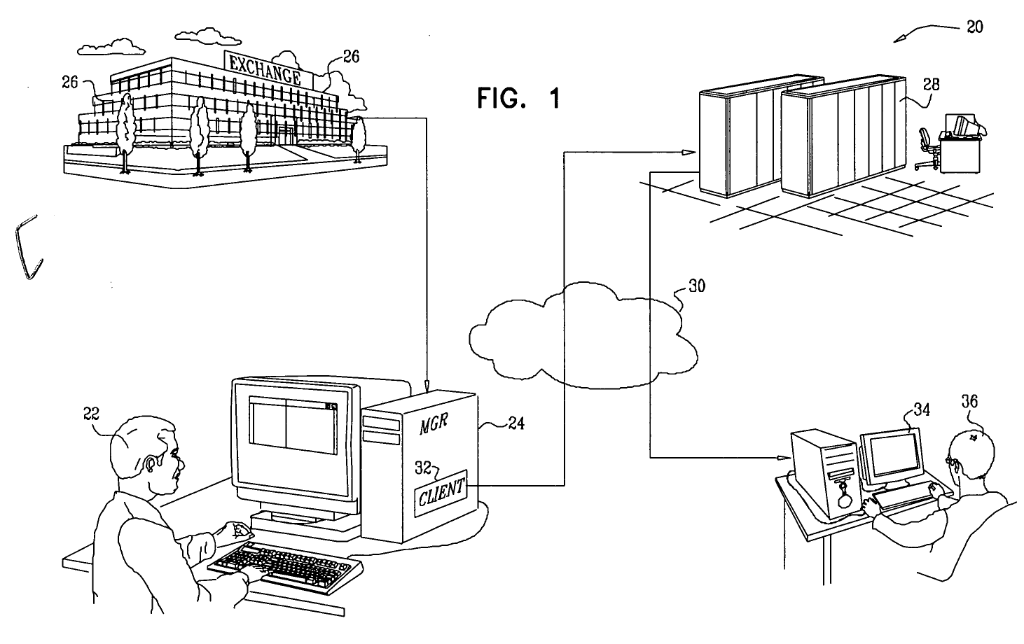

FIG. 1 is a block diagram that schematically illustrates a system 20 for collecting and distributing information regarding trading in financial instruments, in accordance with an embodiment of the present invention. In the scenario shown in FIG. 1, a money manager 22 executes transactions (also referred to as trades) on an exchange 26 using a trading workstation 24. This workstation typically comprises a general-purpose computer, which is programmed in software to enter transactions for execution and for performing the information-gathering functions described hereinbelow.

Exchange 26 may comprise an actual, physical trading room, to which workstation 24 sends transactions entered by manager 22 for execution, or the exchange may comprise, alternatively or additionally, a “virtual exchange,” in the form of a computerized trading forum. Workstation 24 may communicate with exchange 26 directly, as shown in the figure, or it may alternatively conduct transactions in the exchange through an on-line brokerage house or bank, such as E*TRADE. The transactions may involve any sort of financial instruments that are known in the art, such as stocks, bonds, commodities, currencies, options, futures and other derivatives. Although the present embodiment assumes that manager 22 executes actual transactions on a real exchange (whether physical or computerized), workstation 24 may alternatively perform “virtual transactions,” i.e., dummy transactions in which no money or securities actually change hands. In this latter case, the purpose of the transactions is only to test and demonstrate the ability of the manager to trade successfully in financial instruments.

A financial information service, running on a service computer 28, tracks the transactions made by manager 22 as they occur, typically by means of a communication link through a network 30, such as the Internet, between the service and workstation 24. Various means may be used to feed transaction information from the workstation to the service. In the embodiment shown in FIG. 1, a client program 32 is installed on workstation 24 and captures transactions executed by the manager using the workstation. For example, assuming the manager performs transactions via the Web site of a certain brokerage house, client program 32 may be configured to copy the messages sent over the Web between workstation 24 and the brokerage house. The client program typically encrypts the transaction information and transmits it over network 30 using a secure protocol. Alternatively, the functions of service computer 28 may be integrated directly into the information systems of a host trading establishment, such as the brokerage house through which manager 22 executes transactions, in which case client program 32 may not be needed. Further alternatively, manager 22 may enter transaction information manually into a Web page or client program associated with the service.

Service computer 28 provides information to a subscriber 36 regarding the transactions made by manager 22, typically via a network connection between the service and a subscriber workstation 34. Service computer 28 may interface with a Web site, which subscribers may access in order to receive information about money manager 22 and the transactions made by the money manager. Additionally or alternatively, service computer 28 may use other communication applications, such as e-mail or instant messaging, to communicate with workstation 34. Further alternatively or additionally, service computer 28 may communicate with subscriber 36 via other media, such as telephone text messages (SMS), audio messages or pager calls.

For the sake of simplicity, FIG. 1 shows only a single manager 22 and a single subscriber 36. In practice, however, it is expected that service computer 28 will receive information from many different managers and will distribute the information to many different subscribers, in the manner that is described with reference to the single manager and subscriber shown here.

Typically, workstation 24 and service computer 28 comprise general-purpose computers, which are programmed in software to carry out the functions that are described herein. The appropriate software may be downloaded to the computers in electronic form, over a network, for example, or it may be provided and stored on tangible media, such as optical, magnetic or electronic storage media.

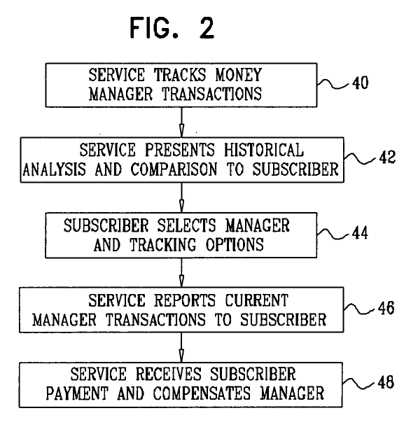

FIG. 2 is a flow chart that schematically illustrates a method for collecting and distributing information regarding trading in financial instruments, in accordance with an embodiment of the present invention. For the sake of convenience and clarity, the method is described hereinbelow with reference to system 20, as shown in FIG. 1. The principles of this method, however, may also be implemented in a wide variety of alternative system configurations, some of which are described above. All such alternative implementations are considered to be within the scope of the present invention.

Service computer 28 tracks the transactions executed by money manager 22 on workstation 24 (and by other money managers on their respective workstations), at a transaction tracking step 40. On this basis, the service is able to maintain historical records of the manager's purchases and sales of financial instruments over time. These records are compared to the subsequent changes in value of these instruments on exchange 26 and other public markets. By combining transaction and market information, service computer 28 is able to assess the manager's performance in terms of standard measures, such as return on investment and risk (which may be based on the variance of the prices of financial instruments held by the manager).

Service computer 28 makes these historical records and analyses available to subscribers, at a historical presentation step 42. Typically, subscribers may view this information by logging into the Web site of the service or in printed publications provided by the service. Subscribers may search the Web site for information regarding a particular manager or regarding a category of managers, such as managers who deal in financial instruments of a certain type. The service may also present comparisons and rankings among different managers, as well as comparison of managers' performance parameters against market indices. Optionally, the service may display, for each manager, how many subscribers have paid to track the manager's transactions, or how many transaction reports have been provided from this manager to subscribers over some time period. In addition to the analytical information provided by service computer 28, managers may also provide general information regarding their investment strategies and practices, as well as quantitative information, such as the amount of money the manager is managing, for subscribers to read on the service Web site.

Some of the historical information and analysis may be provided to subscribers free of charge, while other elements may be provided against payment of a fee. For example, information regarding recent transactions by managers, such as transactions made during the past week, may be available for purchase, while older information is free.

Based on the information provided at step 42, subscriber 36 selects a manager to track, at a manager selection step 44. (It will be assumed for simplicity that the subscriber selects manager 22.) The subscriber may track several managers simultaneously if desired. Service computer 28 may offer different tracking options, each with its own price. For example, the subscriber may ask to track a certain number of transactions executed by the manager, and may be charged for this option at a per-transaction price or package price. As another example, the subscriber may ask to track the manager's transactions over a certain time period, and be charged per unit time (hour, day, month, etc.) and/or per transaction reported during the time period. As still another example, the payment by the subscriber may be based on the performance of a purchased financial instrument over time following the purchase transaction, so that the subscriber pays in proportion to the success of the investment.

The pricing of the selected tracking option is posted by the service, typically on the service Web site. Various different pricing schemes may be used. For example, the service may set standard, uniform prices for all managers. Alternatively, the service may set different prices for different managers, based on ranking and performance parameters. As another option, the service may set a price range for each type of information feed, and permit managers to set their own prices within this range. Further alternatively, managers may be allowed to set their own prices freely.

Once subscriber 36 has input to service computer 28 his selection of manager 22, the service computer begins reporting to the subscriber on transactions executed by the manager, at a reporting step 46. As noted above, client 32 detects transactions that the manager enters on workstation 24, and reports the transactions immediately to service computer 28. Typically, the service computer then reports the transactions immediately to the subscriber. As a result, the subscriber will generally learn of each transaction within a short time, typically less than one minute, of the manager's entry of the transaction on workstation 24. The service may offer to provide transaction information with even shorter time lags, or possibly no time lag at all (if the manager is willing to incur a small delay between entry of the transaction on workstation 24 and the actual execution of the transaction), and may possibly charge premium prices for this sort of expedited service. The service may even offer a super-premium option, in which the manager submits advance notice of transactions that he is about to place, and the subscriber is notified of the transactions even before they are executed.

Upon receiving a report of a transaction entered by manager 22, subscriber 36 may choose to make a similar transaction, and thus benefit in real time from the acumen and up-to-date information that may be available to the manager. Optionally, the subscriber may have the transaction information fed to his own broker, and may instruct the broker to automatically mimic any transaction executed by the manager. This sort of automatic trading functionality is particularly convenient to implement if service computer 28 is integrated into an electronic brokerage house or bank, as noted above. In this case, the subscriber will simply input a standing order to mimic the manager's transactions (typically in some smaller proportion or up to some preset limit). Alternatively, a client program running on subscriber workstation 34 may place transaction orders automatically with a brokerage house or bank based on the information feed from service computer 28.

The service charges subscriber 36 for the information feed, at a payment step 48, according to the pricing of the option selected at step 44. The service pays an agreed percentage of the subscriber payment to the manager from whom the transaction information was received. Thus, managers who attract many subscribers will receive a much larger revenue share than managers with few subscribers.

Additionally or alternatively, subscribers may pay to receive aggregated information regarding the behavior of multiple managers or of all the managers tracked by service computer 28. For example, a subscriber may register to receive an alert whenever a certain percentage of the managers buy or sell a certain security within a preset time period.

The service may be used for other investment advising purposes, as well. For example, subscribers may use the information provided by the service in choosing a fund in which to invest their money, based on the fund manager's performance. The service may then provide real-time information to these subscribers on the actual transactions carried out by the manager of their fund. In this case, the service may collect a matchmaking commission from either the subscriber, the manager, or both.

As another example, the service may be used in pricing an initial public offering (IPO) by presenting the IPO prospectus to managers and/or subscribers, who may then indicate the share price at which they are willing to invest in the IPO. This information may be used in setting the actual share price when the IPO opens on the public exchange.

The service may also offer new types of financial instruments for purchase and sale by its subscribers, or even for trading on public exchanges. Specifically, in one embodiment of the present invention, the service may offer financial instruments whose value is indexed to the performance of a given manager (or a group of managers). For this purpose, service computer 28 may compute an index corresponding to the value of the manager's portfolio in comparison to some baseline value. As the portfolio increases or decreases in value, the index, and hence the value of the financial instrument, rises or drops accordingly.

Although the embodiments described above relate to management of investments in financial instruments, the principles of the present invention may similarly be applied in other sorts of financial dealings. For example, a service similar to that described above may permit subscribers to observe and compare the performance of professional gamblers, and then to receive notice of bets placed by a particular gambler or gamblers that they choose. The terms “transaction” and “money manager” as used herein should thus be understood broadly to comprise any sort of financial dealings that is amenable to the model of information distribution that is described hereinabove and to persons who engage in such dealings.

It will be appreciated that the embodiments described above are cited by way of example, and that the present invention is not limited to what has been particularly shown and described hereinabove. Rather, the scope of the present invention includes both combinations and subcombinations of the various features described hereinabove, as well as variations and modifications thereof which would occur to persons skilled in the art upon reading the foregoing description and which are not disclosed in the prior art.

1. A method for distributing investment data, comprising:
tracking transactions executed by a plurality of money managers while the transactions are in progress;
receiving from a subscriber a selection of at least one money manager from among the plurality; and
responsively to the selection, feeding information to the subscriber, in exchange for a fee, regarding one or more of the transactions executed subsequent to the selection by the at least one money manager selected by the subscriber.

2. The method according to claim 1, wherein the information regarding each transaction is fed to the subscriber within a predetermined time following entry of the transaction by the money manager on a trading workstation.

3. The method according to claim 1, wherein the information regarding each transaction is fed to the subscriber following entry of the transaction by the money manager on a trading workstation but prior to execution of the transaction.

4. The method according to claim 1, and comprising, responsively to the information, mimicking at least one of the transactions automatically in an account of the subscriber, without waiting to receive instructions from the subscriber regarding the at least one of the transactions.

5. The method according to claim 1, wherein receiving the selection comprises receiving from the subscriber a choice of a relative delay, from among a plurality of possible relative delays, between entry of the transaction by the money manager on a trading workstation and feeding the information to the subscriber, and wherein the fee is dependent upon the choice of the relative delay.

6. The method according to claim 1, wherein the fee varies depending upon the selection of the at least one money manager.

7. The method according to claim 1, wherein feeding the information comprises charging the subscriber based on a price per transaction reported to the subscriber.

8. The method according to claim 1, wherein feeding the information comprises charging the subscriber for the information regarding a transaction based on performance of a financial instrument purchased in the transaction.

9. The method according to claim 1, wherein tracking the transactions comprises providing the subscriber with comparative information regarding investment performance of the managers.

10. The method according to claim 1, wherein the at least one money manager comprises two or more of the money managers, and wherein feeding the information comprises presenting aggregated information regarding the transactions executed by the two or more of the money managers.

11. The method according to claim 1, wherein tracking the transactions comprises detecting the transactions executed by the money managers using a client program running on respective workstations used by the money managers to execute the transactions, and reporting the detected transactions from the client program to a service computer, which feeds the information to the subscriber.

12. The method according to claim 1, and comprising offering for sale a financial instrument that is indexed according to investment performance of one of the money managers.

13. Apparatus for distributing investment data, comprising a service computer, which is coupled to track transactions executed by a plurality of money managers while the transactions are in progress, to receive from a subscriber a selection of at least one money manager from among the plurality, and responsively to the selection, to feed information to the subscriber, in exchange for a fee, regarding one or more of the transactions executed subsequent to the selection by the at least one money manager selected by the subscriber.

14. The apparatus according to claim 13, wherein the information regarding each transaction is fed to the subscriber within a predetermined time following entry of the transaction by the money manager on a trading workstation.

15. The apparatus according to claim 13, wherein the information regarding each transaction is fed to the subscriber following entry of the transaction by the money manager on a trading workstation but prior to execution of the transaction.

16. The apparatus according to claim 13, wherein the service computer is coupled to receive from the subscriber a choice of a relative delay, from among a plurality of possible relative delays, between entry of the transaction by the money manager on a trading workstation and feeding the information to the subscriber, and wherein the fee is dependent upon the choice of the relative delay.

17. The apparatus according to claim 13, wherein the service computer is configured to provide the subscriber with comparative information regarding investment performance of the managers.

18. The apparatus according to claim 13, and comprising a plurality of workstations, which are configured to be used by the money managers to execute the transactions, and to run a client program that detects the transactions executed by the money managers and reports the detected transactions to the service computer.

19. A computer software product, comprising a computer-readable medium in which program instructions are stored, which instructions, when read by a computer, cause the computer to track transactions executed by a plurality of money managers while the transactions are in progress, to receive from a subscriber a selection of at least one money manager from among the plurality, and responsively to the selection, to feed information to the subscriber, in exchange for a fee, regarding one or more of the transactions executed subsequent to the selection by the at least one money manager selected by the subscriber.

20. The product according to claim 19, wherein the instructions cause the computer to receive reports from a client program running on a plurality of workstations, which are configured to be used by the money managers to execute the transactions, wherein the client program detects the transactions executed by the money managers and reports the detected transactions to the computer.
